(19) United States
(12) Patent Application Publication
(10) Pub. No.: US 2024/0132266 A1
(43) Pub. Date: Apr. 25, 2024

(54) BIODEGRADABLE REFRESHMENT CONDIMENT SYSTEM

(71) Applicant: VistaPak Industries, Inc., Leesburg, FL (US)

(72) Inventor: Aaron Petersen, Leesburg, FL (US)

(73) Assignee: VistaPak Industries, Inc., Leesburg, FL (US)

(21) Appl. No.: 18/396,330

(22) Filed: Dec. 26, 2023

Related U.S. Application Data
(63) Continuation-in-part of application No. 18/051,453, filed on Oct. 31, 2022.
Application No. 18/051,453 is a continuation-in-part of application No. 17/151,038, filed on Jan. 15, 2021, now abandoned.
(60) Provisional application No. 62/961,641, filed on Jan. 15, 2020.

(51) Int. Cl. B65D 65/46; B01F 33/501; B01F 35/32; B65D 75/06

(52) U.S. Cl. CPC B65D 65/466; B01F 33/5011; B01F 35/32021; B65D 75/06; B01F 2101/14; B65D 2565/385; B65D 2565/388

(57) ABSTRACT

This system is an eco-friendly refreshment condiment system comprising: a container comprising filter material having a rear panel, first side panel and second side panel so that when the first side panel and the second side panel are joined at a seam, a container if defined; a set of packaging contents disposed on the container having one or more items taken from the group of consisting of a sugar packet, sweetener packer, stirring stick and napkin; and, wherein the filter material is eco-friendly, degradable, biodegradable, compostable, recyclable and any combination thereof and comprises fibers having greater than 0.10 mm diameter. The system can include a stirring stick made from wood. The filter material and set of packaging contents can be configured for a one-time use. The panels can be affixed to each other using a biodegradable adhesive.

### RELATED APPLICATIONS

This application is a continuation in part of Non-Provisional Patent Application 18/051,453 which claims priority from U.S. patent application 17/151,038 which claims priority from United States Provisional Patent Application 62/961,641 filed 01/15/2020 each of which are incorporated by reference.

### BACKGROUND OF THE INVENTION

### 1) Field of the Invention

This invention is directed to an eco-friendly coffee condiment system having a non-woven container made from fibers and containing one or more items selected from the group of sugar, sweetener, creamer, napkins, and wooden stirrers.

### 2) Description of the Related Art

Whether for business, leisure, or other reasons, travelers typically stay in temporary housing such as hotels and motels. In the United States, it is estimated that there are over 54,000 hotels amounting to over 5,000,000 guest rooms. When selecting a room, business and leisure travelers select rooms on a number of criteria including price, locations brand and room quality. In fact, a recent study by PwC found that room quality was valued by over 75% of the travelers surveyed and that these travelers reported that room quality is the number one reason for choosing a hotel.

One of the top elements to a high room quality is the complementary refreshments including water, tea, and coffee easily available in-room to the guest. When providing such in-room refreshments condiments are also an important factor. For example, an in-room coffee maker such as United States Patent Application Publication 20050166764 seeks to provide for an electric coffee brewing machine; providing a single-use, disposable brew basket. These single use brewers are designed to offer convenience, reduce maintenance and allow for brewing into a single cup. There has also been an effort to provide for single cup brewing both in hotels and the home such as shown in U.S. Pat. Nos. 6,606,938; 6,655,260; 7,165,488; 7,347,138; 7,360,418; 7,377,162; 7,398,726; 7,513,192; 7,640,845; 8,151,694; 8,495,949; 8,516,948; 8,573,114; 8,609,170; 8,667,892; D513,572; and D544,299. When these type of coffee makers and more traditional beverage makers are placed in a hotel room, there is also the need for condiments to accompany the refreshments. Such condiments can include sugar, sweeteners, creamers, napkins, and stirrers. These condiments can be packaged in a container made from a film such as shown in United States Patent Application Publication 20020006482 that discloses a multilayer blown film structure having a blended polypropylene layer and at least one polyethylene sealant layer. Specifically, such overwrap films are used to contain coffee condiments for single use in the hotel room.

The issues with these traditional condiment containers and wrappers are that they are harmful to the environment. Polypropylene and polyethylene degrade very slowly and sometimes take 20 to 30 years to fully decompose. Using this material for single user containers creates a negative environmental impact both due to volume of material and additives including stabilizers, colorants, and plasticizers. These plastic materials are inconsistent with the desire and trend of the hotel industry to be more eco-friendly. Guests, meeting planners and event planners are increasingly looking for eco-friendly or “green” hotels as selections for their stay. From room keys to sheets and towels, hotels are becoming increasingly concerned with their eco-impact both from a sustainability standpoint and competitions in the marketplace. Using condiment containers made from non-recyclable materials, non-biodegradable and non-compostable materials are contrary to these desires and goals. Having amenities including in-room conveniences that are eco-friendly is a goal that attention should be directed to.

It is desirable for the beverage station to be aesthetically pleasing and have a desirable appearance as this improves the customer experience. The beverage and especially the coffee have been reported to have been included in in between twenty-five and thirty five percent of the reviews of hotels. Part of an aesthetically pleasing appearance includes reducing clutter. The condiments that accompany coffee and other beverages require that there be an inventory of several items in the room that are traditionally individually packaged. Further, maintaining an organized inventory and storage of condiments is challenging and improvements in this area would improve the overall customer experience, reduce staff time in organizing and can lead to reduced costs. Having a condiment package that can be neatly organized would be a benefit to the industry.

Therefore, it is an object of the present invention to provide for a condiment container and condiment system that is eco-friendly.

It is another object of the present invention to provide for a condiment container that can be neatly stored in the room.

### BRIEF SUMMARY OF THE INVENTION

The above objectives are accomplished by providing a biodegradable refreshment condiment system comprising: a container comprising filter material having a rear panel, first side panel and second side panel so that when the first side panel and the second side panel are joined at a seam, a container is defined; a set of packaging contents disposed on the container having one or more items taken from the group consisting of a sugar packet, sweetener packer, stirring stick and napkin; and, wherein the filter material is biodegradable and compostable. In one embodiment the filter material can include fibers in the range of 1 to 7 mm in length. In one embodiment, the filter material can include fibers having a linear density of 0.01 to 8.00 dtex. The system can include a stirring stick made from wood. The filter material and set of packaging contents can be configured for a one-time use. The panels can be affixed to each other using a biodegradable adhesive.

The eco-friendly refreshment condiment system can include a package comprising filter material having a thickness in the range of 0.15 mm to 0.30 mm and a weight in the range of 75 g/m² to 150 g/m²;an interior space defined in the package by a rear panel, first side panel and second side panel included in the package; a set of packaging contents disposed on the container having one or more items taken from a group consisting of a creamer container, sugar packet, a sweetener packer, a stirring stick, a napkin and any combination thereof; wherein the package is made from a filter material that is eco-friendly, degradable, biodegradable, compostable, recyclable and any combination thereof, and comprises fibers having greater than a 0.10 mm diameter.

The sugar packet can have a thickness in the range of 0.15 mm to 0.30 mm and a weight in the range of 75 g/m² to 150 g/m². The sugar packet can include openings 400 pm or less and 50 μm or less. The package can be air and water permeable. The stirring stick can be configured to extend from a first corner to a second corner of the package supporting the package in a rectangular configuration. The filter material and the set of packaging contents can be configured for a one-time use. The panels can be affixed to each other using a biodegradable adhesive.

The package, sugar packet, stirring stick and napkin can be comprised of starch and can be eco-friendly, degradable, biodegradable, compostable, recyclable and any combination thereof. The stirring stick can be made from wood, bamboo, biodegradable plastic and any combination. The stirring stick material can meet the ASTM D5511 and ISODIS15985 standard for anaerobic biodegradability. The creamer container can be made from material taken from the group comprising polylactic acid (PLA), polyhydroxy-alkenoate (PHA), starch, cellulose, bio-based poly-butylene succinate) (bio-PBS) bio-polyethylene (bio-PE) and any combination thereof.

The package can include a non-woven configuration and a mesh structure.

### BRIEF DESCRIPTION OF THE SEVERAL VIEWS OF THE DRAWINGS

The construction designed to carry out the invention will hereinafter be described, together with other features thereof. The invention will be more readily understood from a reading of the following specification and by reference to the accompanying drawings forming a part thereof, wherein an example of the invention is shown and wherein:

FIG. 1 is a schematic of components of the invention;

FIG. 2 is a schematic of components of the invention;

FIG. 3A is a schematic of components of the invention;

FIG. 3B is a schematic of components of the invention;

FIG. 3C is a perspective view of components of the invention;

FIG. 4 is a schematic of components of the invention; and,

FIG. 5 is a schematic of components of the invention.

### DETAILED DESCRIPTION OF THE INVENTION

With reference to the drawings, the invention will now be described in more detail.

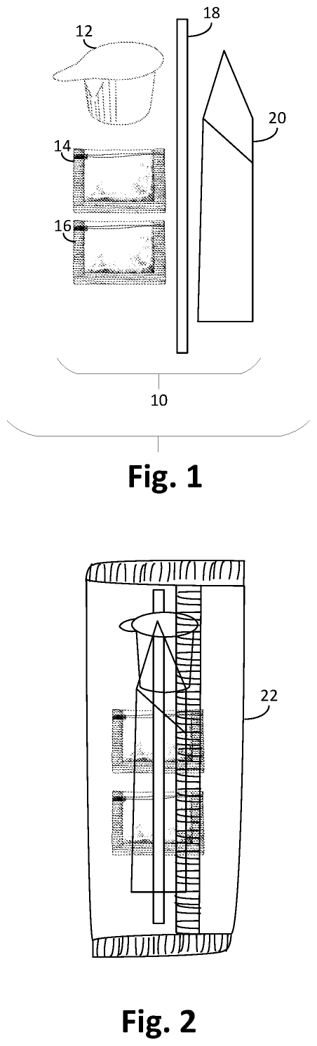

Referring to FIG. 1, a set of condiments 10 is shown that can be used to add convenience to an in-room refreshment maker such as a coffee maker. The set of condiments can include creamer 12, sugar contained in a sugar packet 14, sweetener in a sweetener packet 16, stirring stick 18 and napkin 20. Without packaging, the set of condiments are loose items so that any one item in the set can be misplaced. Further, when a guest arrives in a room, if the condiments are in a loose set, the guest may question the sterilization or sanitation of one or more items given that the set could have been in the room for some period of time, unprotected. Sanitization of hotel rooms is an issue that is of concern to guests so that a loose set of condiments is not desirable. The creamer 12 can be a liquid container that contains the liquid until the package is opened. A liquid creamer can have a shelf life of around 270 days unrefrigerated and unopened. Therefore, it is advantageous to have liquid sealed creamers for individual use for the hospitality industry included in a condiment package. Further, since opened liquid creamers should be used within 24-48 hours of opening, including a single use creamer that is included in the condiment packet which lends itself to immediate use of the creamer reducing the time that the creamer is exposed to the environment after the container is opened.

In the event that the packaging includes powdered creamer, the container of the powdered creamer can be semi-permeable having openings in the powdered creamer packet of 50 μm or less. The powdered creamer package can be made from a biodegradable material or compostable material. The powdered creamer packet can be air permeable and water permeable. The powdered creamer packet can have a thickness greater than 0.15. mm. The powdered creamer packet can have a thickness in the range of 0.15 mm to 0.30 mm. The powdered creamer packet can have a weight in the range of

$$75 \frac{g}{{m}^{2}} to 150 \frac{g}{{m}^{2}} .$$

The container for sugar or sweetener packet can be permeable having openings in the sugar or sweetener packet of 50 μm or less. If the container contains crystal sugar, the opening on the packet can be 400 μm or less. The sugar or sweetener packet can be made from a biodegradable material or compostable material. The sugar or sweetener can be air permeable and water permeable. The sugar or sweetener packet can have a thickness greater than 0.15. mm. The sugar or sweetener packet can have a thickness in the range of 0.15 mm to 0.30 mm. The sugar or sweetener packet can have a weight in the range of

$$75 \frac{g}{{m}^{2}} to 150 \frac{g}{{m}^{2}} .$$

Referring to FIG. 2, the set of condiments can be enclosed in a package 22. The various components can be arranged and generally linear fashion to reduce the footprint of the packaging and reduce the amount of material that is needed for the packaging material. The packaging material can be composed of a biodegradable paper made from fibers. The filter material can include fibers that can be approximately 1.00 to 7.00 mm in length. The filter material can include fiber in the range of 0.01 dtex to 8.00 dtex and can be in a non-woven arrangement and/or mesh structure. In one embodiment, the fibers can be approximately 20.00 mm in wide and can allow particles that are less than approximately 10 to 15 mm to pass through the filter material. The filter material can made from 100 g/m² filter paper where in the filter paper can include long course natural fibers and can be made from bamboo such as bambus. The packaging construction can reduce moisture due to temperature differences from forming inside the packaging by allowing the packaging to breathe by being air permeable. Preventing moisture from forming in the packaging is desirable because moisture negatively effects the contents. For example, moisture in sugar creates undesirable lumps and clumping. The packaging material can be bleached or unbleached for aesthetic purposes.

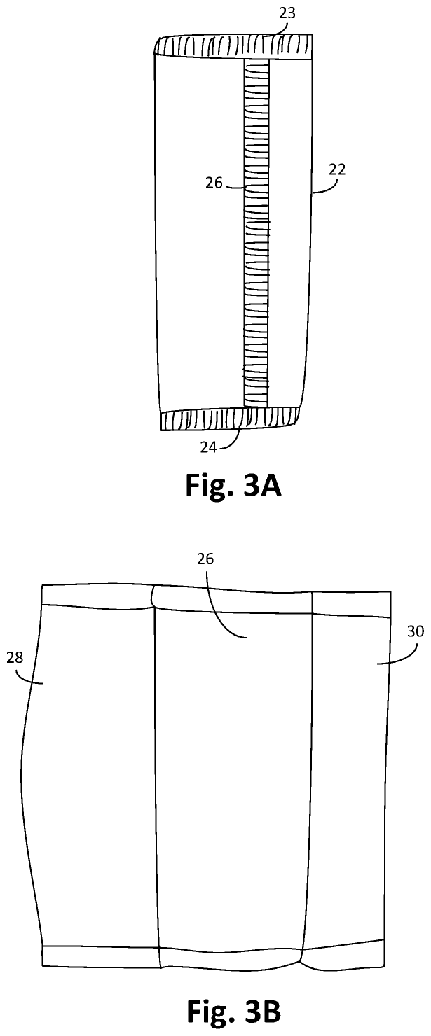

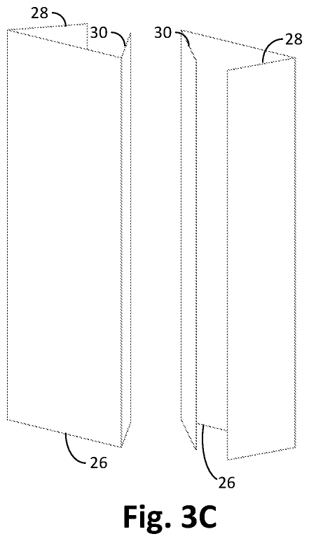

Referring to FIGS. 3A through 3C, the packaging can include a top portion 23, bottom portion 24 and seam 26. In the closed positions, the contents are placed on a rear panel 26 and a first side panel 28 is folded over the contents. A second side panel 30 is then folded partially over the first side panel and the seam is created to define the enclosure for the various components. The packaging material can be bioplastic, biodegradable, eco-friendly, degradable, compostable, recyclable and any combination thereof.

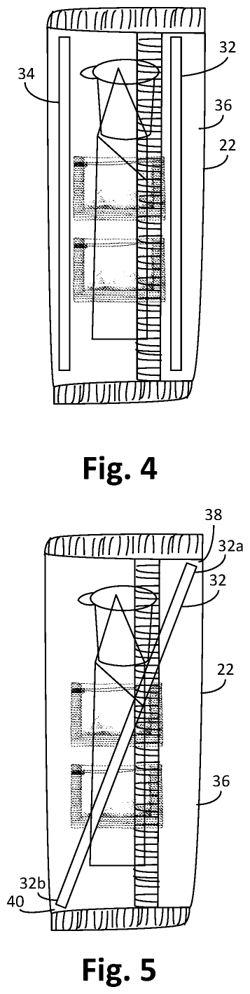

Referring to FIG. 4, the packet 22 an include a first stirring stick 32 and a second stirring stick 34 that are disposed laterally within the package. The stirring sticks can provide support to the package 22 allowing multiple packages to be arranged in a holder such as a tray. The stirring sticks can provide for a rectangular configuration so that the packages can be easily placed and organized in the holder in the room. The stirring sticks can be of a first length that is approximately the same length as the length of the interior space 36 defined by the package.

Referring to FIG. 5, the stirring stick 32 can have a first end 32a disposed at a first corner 38 and a second end 32b disposed at a second corner 40. The first corner can be laterally and diagonally opposite the second corner. The stirring stick can provide support to the package 22 allowing multiple packages to be arranged in a holder such as a tray. The stirring stick can provide for a rectangular configuration so that the package can be easily placed and organized in the holder in the room. The stirring sticks can be of a first length that is approximately the same length in a diagonal line across the interior space 36 defined by the package.

In one embodiment, the filter material is a semi-permeable paper made from a pulp. The pulp can originate from softwood, hardwood, fiber crops, mineral fibers, and any combination thereof. In one embodiment, the filter material can be tissue paper, such as a crêpe paper, that can be coated with a glue-like substance and can be configured to be creased. The glue-like substance can also be known as sizing and can be configured to change the change the absorption and wear characteristics of the filter material. The sizing can be used in the manufacture process for the filter material and can be designed to reduce the filter material's tendency when dry to absorb liquid, allow inks and paints to remain on the surface of the filter material and to dry there, rather than be absorbed into the filter material. The raw material used to make the filter material can include long fibers from fast growing plants and trees thereby making replacement of the raw material more readily and therefore more environmentally friendly.

In one embodiment, the biodegradable adhesive includes an organic material comprising calcium carbonate in the range of 51% to 99% by weight. The organic material can be taken from the group consisting of shrimp, crayfish, crab, lobster, clams, scallops, oysters, mussels and any combination. The organic material can include calcium magnesium, sodium, copper iron, nickel, strontium, and any combination. In one embodiment, the biodegradable adhesive is compostable, repulpable, renewal, recyclable, and any combination. In one embodiment, the organic adhesive disintegrates into non-toxic natural element at a rate consistent with similar organic materials. The adhesive can require microorganisms, humidity, and heat to yield a finished compost product wherein the product can include CO₂, H₂O, inorganic compounds, and biomass.

It is understood that the above descriptions and illustrations are intended to be illustrative and not restrictive. It is to be understood that changes and variations may be made without departing from the spirit or scope of the following claims. Other embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventor did not consider such subject matter to be part of the disclosed inventive subject matter.

What is claimed is:

1. An eco-friendly refreshment condiment system comprising:
a package comprising filter material having a thickness in a range of 0.15 mm to 0.30 mm wherein the filter material is made from fibers having a linear density between 0.01 to 8.00 dtex and the fibers having a diameter greater than 0.10 mm;
an interior space defined in the package by a rear panel, first side panel and second side panel included in the package;
a set of packaging contents disposed in the package having one or more items taken from a group of consisting of a creamer container, a sugar packet, a sweetener packer, a stirring stick, a napkin and any combination thereof;
wherein the package is made from a filter material that is eco-friendly, degradable, biodegradable, compostable, recyclable, repulpable, and any combination thereof.

2. The system of claim 1 wherein the sugar packet has a thickness in the range of 0.15 mm to 0.30 mm and a weight in the range of
$$75 \frac{g}{{m}^{2}} to 150 \frac{g}{{m}^{2}} .$$

3. The system of claim 2 wherein the sugar packet has openings 400 μm or less.

4. The system of claim 3 wherein the sugar packet has openings 50 μm or less.

5. The system of claim 1 wherein the package is air and water permeable.

6. The system of claim 1 wherein the stirring stick is configured to extend from a first corner to a second corner of the package supporting the package in a rectangular configuration.

7. The system of claim 1 wherein the filter material and the set of packaging contents is configured for a one-time use.

8. The system of claim 1 wherein the rear panel, the first side panel and the second side panel are affixed to each other using a biodegradable adhesive.

9. The system of claim 1 wherein the package, the sugar packet, the stirring stick and the napkin are comprised of starch.

10. The system of claim 1 wherein the sugar packet, the stirring stick and the napkin are eco-friendly, degradable, biodegradable, compostable, recyclable and any combination thereof.

11. The system of claim 1 wherein the stirring stick is made from material taken from the group consisting of wood, bamboo, biodegradable plastic and any combination thereof.

12. The system of claim 11 wherein a stirring stick material meets an ASTM D5511 and an ISODIS15985 standard for anaerobic biodegradability.

13. The system of claim 1 wherein the creamer container is made from material taken from the group consisting of polylactic acid (PLA), polyhydroxy-alkenoate (PHA), starch, cellulose, bio-based poly-butylene succinate) (bio-PBS) bio-polyethylene (bio-PE) and any combination thereof.

14. An eco-friendly refreshment condiment system comprising:
a package comprising filter material having a thickness in a range of 0.15 mm to 0.30 mm wherein the filter material is made from fibers having a diameter greater than 0.10 mm;
an interior space defined in the package by a rear panel, first side panel and second side panel included in the package; and,
a set of packaging contents disposed in the package having one or more items taken from a group of consisting of a creamer container, a sugar packet, a sweetener packer, a stirring stick, a napkin and any combination thereof;
wherein the filter material is eco-friendly, degradable, biodegradable, compostable, recyclable and any combination thereof;
wherein the sugar packet, the stirring stick and the napkin are eco-friendly, degradable, biodegradable, compostable, recyclable and any combination thereof, and
the package is sealed with a biodegradable adhesive.

15. The system of claim 14 wherein the sugar packet has openings 400 μm or less.

16. The system of claim 15 wherein the sugar packet has openings 50 μm or less.

17. The system of claim 14 wherein the creamer container is configured to contain a liquid and is made from material taken from the group consisting of polylactic acid (PLA), polyhydroxy-alkenoate (PHA), starch, cellulose, bio-based poly-butylene succinate) (bio-PBS) bio-polyethylene (bio-PE) and any combination thereof.

18. The system of claim 14 wherein the creamer container is configured to contain a powdered creamer and the creamer container has a thickness in the range of 0.15 mm to 0.30 mm and a weight in the range of
$$75 \frac{g}{{m}^{2}} to 150 \frac{g}{{m}^{2}} .$$

19. An eco-friendly refreshment condiment system comprising:
a package comprising filter material having a thickness in a range of 0.15 mm to 0.30 mm wherein the filter material is made from fibers having a length between 1.00 to 7.00 mm and a linear density between 0.01 dtex to 8.00 dtex;
an interior space defined in the package by a rear panel, first side panel and second side panel included in the package;
a set of packaging contents disposed in the package having one or more items taken from a group of consisting of a creamer container, sugar packet, a sweetener packer, a stirring stick, a napkin and any combination thereof; and,
wherein the filter material that is eco-friendly, degradable, biodegradable, compostable, recyclable, repulpable and any combination thereof wherein the fiber includes a diameter of greater than 0.10 mm and,
wherein the sugar packet, stirring stick and napkin are biodegradable.

20. The system of claim 19 where in the package includes a non-woven configuration and a mesh structure.
